(19) United States
(12) Patent Application Publication
(10) Pub. No.: US 2024/0313484 A1
(43) Pub. Date: Sep. 19, 2024

(54) ELECTRICAL CONNECTOR WITH SHUNT FOR PRIVACY GLAZING STRUCTURE

(71) Applicant: CARDINAL IG COMPANY, Eden Prairie, MN (US)

(72) Inventors: Eric BERNER, Ramsey, MN (US); Zachary FRANZ, Golden Valley, MN (US)

(21) Appl. No.: 18/550,311

(22) PCT Filed: Mar. 17, 2022
(86) PCT No.: PCT/US2022/020837

§ 371 Date: Sep. 13, 2023

Related U.S. Application Data
(60) Provisional application No. 63/162,058, filed on Mar. 17, 2021.

(51) Int. Cl. H01R 13/66; H01R 13/24; H01R 13/50

(52) U.S. Cl. CPC H01R 13/665; H01R 13/2421; H01R 13/50

(57) ABSTRACT

A switchable glazing can include an electrically controllable optically active material controllable to vary the visibility through the glazing structure. The switchable glazing can be movable relative to a surrounding frame, such as when implemented as a door or window. In some examples, the glazing can include a plurality of electrical connectors that can electrically connect to corresponding electrical connectors in the frame when the glazing is moved to a first position and electrically disconnect when the glazing is moved to a second position. Upon disconnecting, electrical connectors associated with the glazing can electrically connect with each other, shorting the electrically controllable optically active material. This can remove the potential energy otherwise stored in the material for increased safety and/or enhanced optics.

### CROSS REFERENCE

This application claims the benefit of U.S. Provisional Patent Application No. 63/162,058, filed Mar. 17, 2021, the entire contents of which are incorporated herein by reference.

### TECHNICAL FIELD

This disclosure relates to structures that include an electrically controllable optically active material and, more particularly, to electrical connections for such structures.

### BACKGROUND

Windows, doors, partitions, and other structures having controllable light modulation have been gaining popularity in the marketplace. These structures are commonly referred to as “smart” structures or “privacy” structures for their ability to transform from a transparent state in which a user can see through the structure to a private state in which viewing is inhibited through the structure. For example, smart windows are being used in high-end automobiles and homes and smart partitions are being used as walls in office spaces to provide controlled privacy and visual darkening.

A variety of different technologies can be used to provide controlled optical transmission for a smart structure. For example, electrochromic technologies, photochromic technologies, thermochromic technologies, suspended particle technologies, and liquid crystal technologies are all being used in different smart structure applications to provide controllable privacy. The technologies generally use an energy source, such as electricity, to transform from a transparent state to a privacy state or vice versa.

In practice, one or more electrical connectors may be used to connect the optically active material to power. The electrical connectors may connect wires running from a power source to the optically active material to enable power to flow to the optically active material. The electrical connectors may be designed to allow a window, door, or other structure that includes an optically active materials to open and close.

### SUMMARY

In general, this disclosure is directed to electrical connectors for providing power to privacy structures incorporating an electrically controllable optically active material, privacy structures utilizing such electrical connectors, and techniques for electrically controlling privacy structures. The privacy structures can be implemented in the form of a window, door, skylight, interior partition, or yet another structure where controllable visible transmittance is desired.

In general, the privacy structure may include a stationary portion and a movable portion that allows at least a portion of the privacy structure to be moved relative to the stationary portion to open and close the structure. For example, the privacy structure may include a frame surrounding a wall cavity/opening in which the privacy structure is mounted. The privacy structure may also include a sash surrounding the portion of the structuring containing the electrically controllable optically active material (e.g., a sash surrounding a cell containing the electrically controllable optically active material and/or an insulating glazing unit containing the electrically controllable optically active material). The sash may be moved relative to the frame to open and close the privacy structure (e.g., opening or closing a pathway between an interior environment on one side of the privacy structure and an exterior environment on an opposite side of the privacy structure). In different implementations, the movable portion may move relative to the stationary portion about a hinged connection and/or by sliding relative to the stationary portion. Example types of windows that may include an electrical connector configuration according to the disclosure include, but are not limited to, a casement window, a single hung window, a double hung window, a gliding or horizontally sliding window, and an awning window. Example types of doors that may include an electrical connector configuration according to the disclosure include, but are not limited to, a sliding door and a hinged door.

In accordance with some implementations of the present disclosure, the privacy structure includes one or more pairs of complementary electrical connectors, with one portion of the pair of complementary electrical connectors being operatively connected to a movable portion of the privacy structure and another portion of the pair of complementary electrical connectors being operatively connected to the stationary portion of the privacy structure. For example, each pair of electrical connectors may be defined by complementary male and female electrical connectors that mechanical and/or electrically interconnect with the movable portion is in a closed position but that mechanical and/or electrically disconnect with the movable portion is in a partially and/or fully open position. In either case, one of the pair of complementary connectors may extend partially or fully through the sash of the privacy structure and be electrically connected to an electrode layer for controlling the electrically controllable optically active material. Another of the pair of complementary connectors may extend partially or fully through the frame of the privacy structure and be connected, directly or indirectly, to a power source for supplying power to electrically controllable optically active material (e.g., when the privacy structure is closed and the electrical complementary connectors are electrically connected).

In practice, as the user moves the movable portion of the privacy structure from a closed position to an open position, the pair of complementary electrical connectors may mechanically and/or electrically decouple from each other. This can break the supply of power from the power source to the electrically controllable optically active material. The electrically controllable optically active material may behave as a capacitor and/or carry a capacitive load even after power supply to the electrically controllable optically active material is broken. As a result, the electrically controllable optically active material may maintain a residual electrical charge. As a result, the one or more electrical connectors operatively connected to the movable portion of the privacy structure may present a residual shock hazard to a user of the window, door, or other movable portion. Additionally or alternatively, in some implementations, the optics of the privacy structure (e.g., the level of optical obscuring or darkness through the electrically controllable optically active material) may deteriorate over time as the residual electrical charge held by the electrically controllable optically active material bleeds away. This can be visually unappealing in some implementations.

In accordance with some examples of the present disclosure, an electrical connector configuration is provided for a privacy structure that helps clear a residual electrical charge carried by the electrically controllable optically active material when the movable portion of the privacy structure is moved to an open position. For example, the electrical connector configuration may include a shunt bridging between a set of (e.g., adjacent) electrical connectors operatively connected to the movable portion (e.g., positive and negative lines/electrodes). The electrical connectors may be biased against the shunt but movable out of physical and/or electrical contact with the shunt when the movable portion is in a closed position. When the movable portion of the privacy structure is moved to an open position, the electrical connectors may move in physical and/or electrical contact with the shunt, creating an electrical short that clears (e.g., zeros) the residual electrical charge carried by the electrically controllable optically active material. This can provide safety benefits by discharging the capacitive load of the structure and/or visual benefits by precluding bleeding of the electrical charge and attendant visual deterioration associated with the electrical change.

As another example, the electrical connector configuration may include a set of (e.g., adjacent) electrical connectors operatively connected to the movable portion (e.g., positive and negative lines/electrodes) that are designed to physically and/or electrically contact each other when the movable portion is moved to an open position. For example, the electrical connectors may be angled and/or movable relative to each other. When the movable position of the privacy structure is in a closed position, the electrical connectors may be out of contact with each other. When the movable portion of the privacy structure is moved to an open position, the electrical connectors may move in physical and/or electrical contact each other, creating an electrical short that clears (e.g., zeros) the residual electrical charge carried by the electrically controllable optically active material.

In any case, a privacy structure may be fabricated from multiple panes of transparent material that include an electrically controllable medium between the panes. Each pane of transparent material can carry an electrode layer, which may be implemented as a layer of electrically conductive and optically transparent material deposited over the pane. The optically active material may be controlled and/or powered, for example, via an electrical controller coupled to the electrode layers by electrical connectors, e.g., by controlling the application and/or removal of electrical energy to the optically active material. For example, the controller can control application and/or removal of electrical energy from the optically active material, thereby causing the optically active material to transition from a scattering state in which visibility through the structure is inhibited to a transparent state in which visibility through the structure is comparatively clear.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a side view of an example privacy structure.

FIG. 2 is a side view of the example privacy structure of FIG. 1 incorporated into a multi-pane insulating glazing unit.

FIG. 3 is a schematic illustration showing an example electrical connection between a privacy structure and a frame according to an aspect of the present disclosure.

FIG. 4 is a block diagram of an electrical dynamic structure system including a privacy structure, a frame, a controller, a switch, and electrical connections therebetween according to an aspect of the present disclosure.

FIG. 5A and FIG. 5B are isometric views of an example four pin electrical connection in a compressed and an extended state according to an aspect of the present disclosure.

FIG. 6A and FIG. 6B are isometric views of the example four pin electrical connection of FIG. 5A and FIG. 5B in a compressed and an extended state according to an aspect of the present disclosure.

FIG. 7A is an isometric view of an example three pin electrical connection in an extended state according to an aspect of the present disclosure.

FIG. 8 is an isometric view of an example three pin electrical connection in a compressed state according to an aspect of the present disclosure.

FIG. 9 is a flow chart of an example method of connecting a privacy structure comprising an electrically controllable optically active material to a controller configured to provide power to the electrically controllable optically active material according to an aspect of the present disclosure.

### DETAILED DESCRIPTION

In general, the present disclosure is directed to electrical connector systems for connecting optical structures (e.g., windows, doors) having controllable light modulation to a power source. For example, an optical structure can include an electrically controllable optically active material that provides controlled transition between a privacy or scattering state and a visible or transmittance state. The privacy or scattering state can provide a relatively greater amount of darkening or privacy than the corresponding bright or visible state. The optical structures can include electrical connectors, e.g., in the form of pins and contact pads, that can be electrically coupled to optically active material through electrode layers bounding the optically active material. An electrical controller can receive power from a power source and can deliver power to the electrodes via electrical connectors. In addition, in response to a user input or other control information, the electrical controller may change an electrical signal delivered to the electrodes and/or cease delivering electricity to the electrodes. Accordingly, the electrical controller can control the electrical signal delivered to the optically active material, thereby controlling the material to maintain a specific optical state or to transition from one state (e.g., a transparent state or scattering state) to another state.

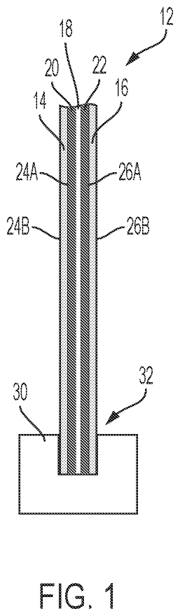

FIG. 1 is a side view of an example privacy glazing structure 12 that includes a first pane of transparent material 14 and a second pane of transparent material 16 with a layer of optically active material 18 bounded between the two panes of transparent material. The privacy glazing structure 12 also includes a first electrode layer 20 and a second electrode layer 22. The first electrode layer 20 is carried by the first pane of transparent material 14 while the second electrode layer 22 is carried by the second pane of transparent material. In operation, electricity supplied through the first and second electrode layers 20, 22 can control the optically active material 18 to control visibility through the privacy glazing structure.

Privacy glazing structure 12 can utilize any suitable privacy materials for the layer of optically active material 18. Further, although optically active material 18 is generally illustrated and described as being a single layer of material, it should be appreciated that a structure in accordance with the disclosure can have one or more layers of optically active material with the same or varying thicknesses. In general, optically active material 18 is configured to provide controllable and reversible optical obscuring and lightening. Optically active material 18 can be an electronically controllable optically active material that changes direct visible transmittance in response to changes in electrical energy applied to the material.

In one example, optically active material 18 is formed of an electrochromic material that changes opacity and, hence, light transmission properties, in response to voltage changes applied to the material. Typical examples of electrochromic materials are WO₃ and MoO₃, which are usually colorless when applied to a substrate in thin layers. An electrochromic layer may change its optical properties by oxidation or reduction processes. For example, in the case of tungsten oxide, protons can move in the electrochromic layer in response to changing voltage, reducing the tungsten oxide to blue tungsten bronze. The intensity of coloration is varied by the magnitude of charge applied to the layer.

In another example, optically active material 18 is formed of a liquid crystal material. Different types of liquid crystal materials that can be used as optically active material 18 include polymer dispersed liquid crystal (PDLC) materials and polymer stabilized cholesteric texture (PSCT) materials. Polymer dispersed liquid crystals usually involve phase separation of nematic liquid crystal from a homogeneous liquid crystal containing an amount of polymer, sandwiched between electrode layers 20 and 22. When the electric field is off, the liquid crystals may be randomly scattered. This scatters light entering the liquid crystal and diffuses the transmitted light through the material. When a certain voltage is applied between the two electrode layers, the liquid crystals may homeotropically align and the liquid crystals increase in optical transparency, allowing light to transmit through the crystals.

In the case of polymer stabilized cholesteric texture (PSCT) materials, the material can either be a normal mode polymer stabilized cholesteric texture material or a reverse mode polymer stabilized cholesteric texture material. In a normal polymer stabilized cholesteric texture material, light is scattered when there is no electrical field applied to the material. If an electric field is applied to the liquid crystal, it turns to the homeotropic state, causing the liquid crystals to reorient themselves parallel in the direction of the electric field. This causes the liquid crystals to increase in optical transparency and allows light to transmit through the liquid crystal layer. In a reverse mode polymer stabilized cholesteric texture material, the liquid crystals are transparent in the absence of an electric field (e.g., zero electric field) but opaque and scattering upon application of an electric field.

In one example in which the layer of optically active material 18 is implemented using liquid crystals, the optically active material includes liquid crystals and a dichroic dye to provide a guest-host liquid crystal mode of operation. When so configured, the dichroic dye can function as a guest compound within the liquid crystal host. The dichroic dye can be selected so the orientation of the dye molecules follows the orientation of the liquid crystal molecules. In some examples, when an electric field is applied to the optically active material 18, there is little to no absorption in the short axis of the dye molecule, and when the electric field is removed from the optically active material, the dye molecules absorb in the long axis. As a result, the dichroic dye molecules can absorb light when the optically active material is transitioned to a scattering state. When so configured, the optically active material may absorb light impinging upon the material to prevent an observer on one side of privacy glazing structure 12 from clearly observing activity occurring on the opposite side of the structure.

When optically active material 18 is implemented using liquid crystals, the optically active material may include liquid crystal molecules within a polymer matrix. The polymer matrix may or may not be cured, resulting in a solid or liquid medium of polymer surrounding liquid crystal molecules. In addition, in some examples, the optically active material 18 may contain spacer beads (e.g., micro-spheres), for example having an average diameter ranging from 3 micrometers to 40 micrometers, to maintain separation between the first pane of transparent material 14 and the second pane of transparent material 16.

In another example in which the layer of optically active material 18 is implemented using a liquid crystal material, the liquid crystal material turns hazy when transitioned to the privacy state. Such a material may scatter light impinging upon the material to prevent an observer on one side of privacy glazing structure 12 from clearly observing activity occurring on the opposite side of the structure. Such a material may significantly reduce regular visible transmittance through the material (which may also be referred to as direct visible transmittance) while only minimally reducing total visible transmittance when in the privacy state, as compared to when in the light transmitting state. When using these materials, the amount of scattered visible light transmitting through the material may increase in the privacy state as compared to the light transmitting state, compensating for the reduced regular visible transmittance through the material. Regular or direct visible transmittance may be considered the transmitted visible light that is not scattered or redirected through optically active material 18. In various implementations, the liquid crystal material may promote a bright state, darkened state, selectively colored, and/or substantially reflective state depending on the electrical input and/or characteristics of the liquid crystal material.

Another type of material that can be used as the layer of optically active material 18 is a suspended particle material. Suspended particle materials are typically dark or opaque in a non-activated state but become transparent when a voltage is applied. Other types of electrically controllable optically active materials can be utilized as optically active material 18, and the disclosure is not limited in this respect.

Independent of the specific type of material(s) used for the layer of optically active material 18, the material can change from a light transmissive state in which privacy glazing structure 12 is intended to be transparent to a privacy state in which visibility through the insulating glazing unit is intended to be blocked or otherwise limited. Optically active material 18 may exhibit progressively decreasing direct visible transmittance when transitioning from a maximum light transmissive state to a maximum privacy state. Similarly, optically active material 18 may exhibit progressively increasing direct visible transmittance when transitioning from a maximum privacy state to a maximum transmissive state. The speed at which optically active material 18 transitions from a generally transparent transmission state to a generally opaque privacy state may be dictated by a variety of factors, including the specific type of material selected for optically active material 18, the temperature of the material, the electrical voltage applied to the material, and the like.

To electrically control optically active material 18, privacy glazing structure 12 in the example of FIG. 1 includes first electrode layer 20 and second electrode layer 22. Each electrode layer may be in the form of an electrically conductive coating deposited on or over the surface of each respective pane facing the optically active material 18. For example, the first pane of transparent material 14 may define an inner surface 24A and an outer surface 24B on an opposite side of the pane. Similarly, the second pane of transparent material 16 may define an inner surface 26A and an outer surface 26B on an opposite side of the pane. First electrode layer 20 can be deposited over the inner surface 24A of the first pane, while second electrode layer 22 can be deposited over the inner surface 26A of the second pane. The first and second electrode layers 20, 22 can be deposited directed on the inner surface of a respective pane or one or more intermediate layers, such as a blocker layer, and be deposited between the inner surface of the pane and the electrode layer.

Each electrode layer 20, 22 may be an electrically conductive coating that is a transparent conductive oxide (“TCO”) coating, such as aluminum-doped zinc oxide and/or tin-doped indium oxide. The transparent conductive oxide coatings can be electrically connected to a power source through notch structures as described in greater detail below. In some examples, the transparent conductive coatings forming electrode layers 20, 22 define wall surfaces of a cavity between the first pane of transparent material 14 and the second pane of transparent material 16 which optically active material 18 contacts. In other examples, one or more other coatings may overlay the first and/or second electrode layers 20, 22, such as a dielectric overcoat (e.g., silicon oxynitride). In either case, the first pane of transparent material 14 and second pane of transparent material 16, as well as any coatings on inner faces 24A, 26A of the panes can form a cavity or chamber containing optically active material 18.

The panes of transparent material forming privacy glazing structure 12, including the first pane 14 and the second pane 16, and be formed of any suitable material. Each pane of transparent material may be formed from the same material, or at least one of the panes of transparent material may be formed of a material different from at least one other of the panes of transparent material. In some examples, at least one (and optionally all) the panes of privacy glazing structure 12 are formed of glass. In other examples, at least one (and optionally all) the privacy glazing structure 12 are formed of plastic such as, e.g., a fluorocarbon plastic, polypropylene, polyethylene, or polyester. When glass is used, the glass may be aluminum borosilicate glass, sodium-lime (e.g., sodium-lime-silicate) glass, or another type of glass. In addition, the glass may be clear or the glass may be colored, depending on the application. Although the glass can be manufactured using different techniques, in some examples the glass is manufactured on a float bath line in which molten glass is deposited on a bath of molten tin to shape and solidify the glass. Such an example glass may be referred to as float glass.

In some examples, first pane 14 and/or second pane 16 may be formed from multiple different types of materials. For example, the substrates may be formed of a laminated glass, which may include two panes of glass bonded together with a polymer such as polyvinyl butyral. Additional details on privacy glazing substrate arrangements that can be used in the present disclosure can be found in US Patent Publication No. 2018/0307111, titled “HIGH PERFORMANCE PRIVACY GLAZING STRUCTURES” and filed Apr. 20, 2018, the entire contents of which are incorporated herein by reference.

Privacy glazing structure 12 can be used in any desired application, including in a door, a window, a wall (e.g., wall partition), a skylight in a residential or commercial building, or in other applications. To help facilitate installation of privacy glazing structure 12, the structure may include a sash 30 surrounding the exterior perimeter of the structure. In different examples, sash 30 may be fabricated from wood, metal, or a plastic material such a vinyl. sash 30 may define a channel 32 that receives and holds the external perimeter edge of structure 12.

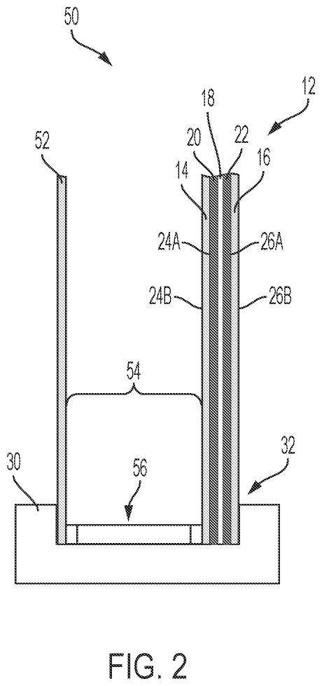

In the example of FIG. 1, privacy glazing structure 12 is illustrated as a privacy cell formed of two panes of transparent material bounding optically active material 18. In other configurations, privacy glazing structure 12 may be incorporated into a multi-pane glazing structure that includes a privacy cell having one or more additional panes separated by one or more between-pane spaces. FIG. 2 is a side view of an example configuration in which privacy glazing structure 12 from FIG. 1 is incorporated into a multi-pane insulating glazing unit having a between-pane space.

As shown in the illustrated example of FIG. 2, a multi-pane privacy glazing structure 50 may include privacy glazing structure 12 separated from an additional (e.g., third) pane of transparent material 52 by a between-pane space 54, for example, by a spacer 56. Spacer 56 may extend around the entire perimeter of multi-pane privacy glazing structure 50 to hermetically seal the between-pane space 54 from gas exchange with a surrounding environment. To minimize thermal exchange across multi-pane privacy glazing structure 50, between-pane space 54 can be filled with an insulative gas or even evacuated of gas. For example, between-pane space 54 may be filled with an insulative gas such as argon, krypton, or xenon. In such applications, the insulative gas may be mixed with dry air to provide a desired ratio of air to insulative gas, such as 10 percent air and 90 percent insulative gas. In other examples, between-pane space 54 may be evacuated so that the between-pane space is at vacuum pressure relative to the pressure of an environment surrounding multi-pane privacy glazing structure 50.

Spacer 56 can be any structure that holds opposed substrates in a spaced apart relationship over the service life of multi-pane privacy glazing structure 50 and seals between-pane space 54 between the opposed panes of material, e.g., so as to inhibit or eliminate gas exchange between the between-pane space and an environment surrounding the unit. One example of a spacer that can be used as spacer 56 is a tubular spacer positioned between the first pane of transparent material 14 and third pane of transparent material 52. The tubular spacer may define a hollow lumen or tube which, in some examples, is filled with desiccant. The tubular spacer may have a first side surface adhered (by a first bead of sealant) to the outer surface 24B of first pane of transparent material 14 and a second side surface adhered (by a second bead of sealant) to third pane of transparent material 52. A top surface of the tubular spacer can be exposed to between-pane space 54 and, in some examples, includes openings that allow gas within the between-pane space to communicate with desiccating material inside of the spacer. Such a spacer can be fabricated from aluminum, stainless steel, a thermoplastic, or any other suitable material.

Another example of a spacer that can be used as spacer 56 is a spacer formed from a corrugated metal reinforcing sheet surrounded by a sealant composition. The corrugated metal reinforcing sheet may be a rigid structural component that holds the first pane of transparent material 14 apart from the third pane of transparent material 52. In yet another example, spacer 56 may be formed from a foam material surrounded on all sides except a side facing a between-pane space with a metal foil. As another example, spacer 56 may be a thermoplastic spacer (TPS) spacer formed by positioning a primary sealant (e.g., adhesive) between the first pane of transparent material 14 and the third pane of transparent material 52 followed, optionally, by a secondary sealant applied around the perimeter defined between the substrates and the primary sealant. Spacer 56 can have other configurations, as will be appreciated by those of ordinary skill in the art.

Depending on application, first patent of transparent material 14, second pane of transparent material 16, and/or third pane of transparent material 52 (when included) may be coated with one or more functional coatings to modify the performance of privacy structure. Example functional coatings include, but are not limited to, low-emissivity coatings, solar control coatings, and photocatalytic coatings. In general, a low-emissivity coating is a coating that is designed to allow near infrared and visible light to pass through a pane while substantially preventing medium infrared and far infrared radiation from passing through the panes. A low-emissivity coating may include one or more layers of infrared-reflection film interposed between two or more layers of transparent dielectric film. The infrared-reflection film may include a conductive metal like silver, gold, or copper. A photocatalytic coating, by contrast, may be a coating that includes a photocatalyst, such as titanium dioxide. In use, the photocatalyst may exhibit photoactivity that can help self-clean, or provide less maintenance for, the panes.

The electrode layers 20, 22 of privacy glazing structure 12, whether implemented alone or in the form of multiple-pane structure with a between-pane space, can be electrically connected to a power source, e.g., via a controller. The controller can provide power to the electrode layers, which may be an electrical signal of a defined current, voltage, and waveform to control optically active material 18. In some examples, the controller can be electrically connected (e.g., by wires) to the electrode layers to provide the electrode layers with power. One electrode layer can have a positive charge while the other electrode layer has a negative charge to create a potential difference across the layers. Power supply to the electrode layers can be direct current (DC) or alternating current (AC) in which the polarity of the current alternates at a given frequency.

In practice, in may be desirable for privacy glazing structure 12 to be openable and closable. For example, at least a portion of the privacy glazing structure 12, when opened, can separate from a surrounding structure (e.g., frame). An electrical connection, as described herein, between the controller and the electrode layers can enable the privacy glazing structure 12 to be openable and to allow the controller to provide power to the privacy structure 12 when it is closed.

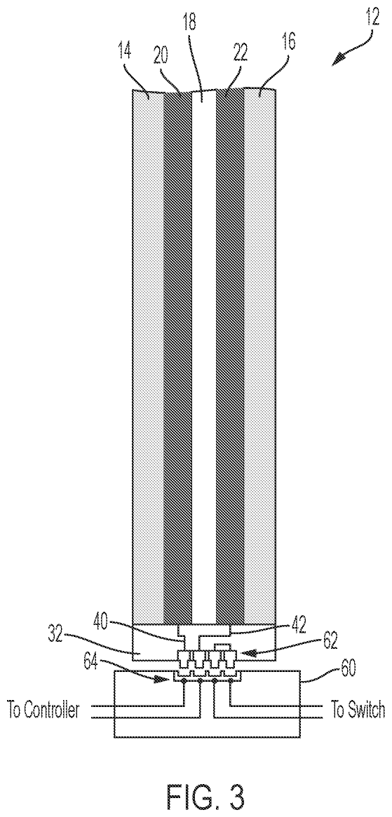

FIG. 3 is a schematic illustration showing an example electrical connection configuration between privacy structure 12 and a surrounding frame 60. In various examples, frame 60 may be a window frame or a door frame and privacy structure 12, including a sash 30 surrounding a perimeter of the privacy structure, can be movable relative to the frame to open and close the window or door.

In the illustrated example, wires 40 and 42 connect to the first electrode layer 20 and the second electrode layer 22, respectively. In some examples, wire 40 and/or wire 42 may connect to their respective electrode layers via a conduit or hole in the transparent pane adjacent to the electrode layer. In other configurations, wire 40 and/or wire 42 may contact their respective electrode layers at the edge of the privacy structure 12 without requiring wire 40 and/or wire 42 to extend through other sections (e.g., transparent panes 14, 16) to reach the respective electrode layer(s). For example, the plurality of wires electrically connected to first electrode layer 20 and the second electrode layer 22 may extend through sash 32 to a perimeter edge of the sash.

The wires 40, 42 electrically connect to electrical connectors 62, which are illustrated in the form of pins although can have other configurations without departing from the scope of the disclosure. In the embodiment of FIG. 3, the wires electrically connect to two of the pins 62 with each wire connected to one of the two pins. In some embodiments, the wire connected to the first electrode layer 20 is connected to a first pin while the wire connected to the second electrode layer 20 is connected to second pin. The electrical connection between the wires and the two pins can provide an electrical path between the electrode layers 20, 22, and the pins 62. For example, the first electrode layer 20 can be electrically connected to a first pin via a wire and the second electrode layer 22 can be electrically connected to the second pin via a wire. In some embodiments, the pins 62 are electrically isolated from each other such that each pin can be separately connected to another component. For example, in FIG. 3, the first electrode layer 20 connected to the first pin via a wire can be electrically isolated (not electrically connected) to the second electrode layer 22 connected to the second pin via a wire.

While shown separated in FIG. 3, the pins 62 of the privacy structure can be electrically connected to complementary electrically connectors 64 of frame 60, which are illustrated in the form of contact pads although can have other configurations without departing from the scope of the disclosure. The connectors carried by the movable privacy glazing 12 (e.g., by sash 32 surrounding privacy glazing) can be electrically connected to the complementary electrical connectors extending through frame 30 (e.g., when the privacy glazing is moved to a first position, such as a closed position) and electrically disconnected (e.g., when the privacy glazing is moved to a second position, such as an open position). Power can be provided to the electrically controllable optically active material via the electrode layers and electrically-connected connectors 62 from a power source via the complementary connectors 64, when the connectors 62 and complementary connectors 64 are engaged. Power delivery to the electrically controllable optically active material can terminate when the connectors 62 are electrically disengaged from the complementary connectors 64, e.g., by physically moving sash 32 relative to frame 60.

For example, in the illustrated configuration, the pins 62 and the contact pads 64 can be brought together such that the pins 62 physically contact the contact pads 64. Each of the pins 62 can contact a corresponding contact pad when the pins 62 and the contact pads 64 are brought together. As the pins and the contact pads can be made from electrically conductive materials, contact between the pins 62 and the contact pads 64 can enable electricity to flow therebetween. In some embodiments, the contact pads are electrically isolated from each other such that each contact pad can be separately connected to another component. For example, each contact pad of the plurality (e.g., four) contact pads illustrated in FIG. 3 can be electrically isolated from the other of the plurality (e.g., three) contact pads. In some embodiments, each of the pins 62 can connect to and engage with a corresponding contact pad. The engagement can be electrical engagement and/or mechanical engagement.

The specific example of FIG. 3 includes four contact pads, which can include a first contact pad and a second contact pad. The first contact pad of the frame 60 can correspond to a first pin of the privacy structure 12 with a second contact pad can correspond to a second pin of the privacy structure. In some embodiments, the contact pads 64 of the frame 60 can be further electrically connected (e.g., via wires) to other components such as a controller and/or a switch as illustrated in FIG. 3. In some such embodiments, should the pins 62 of the privacy structure be engaged with and electrically connected to the contact pads 64 of the frame, the pins 62, and thus the electrode layers 20, 22, can be in electrical communication with the other components including the controller and/or the switch.

In operation, a controller can provide power to the contact pads to which it is connected. The contact pads, when engaged with pins electrically connected to the electrode layers 20, 22, can enable power to flow through the pins and into the electrode layers 20, 22. The power, which can include a voltage and a current, delivered to the electrode layers 20, 22 can result in an electric field across optically active material 18. The optical properties of the optically active material 18 can be adjusted, e.g., by applying different voltages across the layer. In some embodiments, the effect of the voltage on the optically active material 18 is independent of the polarity of the applied voltage. For example, in some examples in which optically active material 18 comprises liquid crystals that align with an electric field between electrode layers 20 and 22, the optical result of the crystal alignment is independent of the polarity of the electric field. For instance, liquid crystals may align with an electric field in a first polarity, and may rotate approximately 180° in the event the polarity if reversed. However, the optical state of the liquid crystals (e.g., the opacity) in either orientation may be approximately the same.

While the illustrated embodiments of FIG. 3 and subsequent figures depict a privacy structure comprising pins and a frame comprising contact pads, in some embodiments, the privacy structure comprises pins and the frame comprises contact pads. In such embodiments, electrical connections to the pins and the contact pads can be reversed relative to the illustrated embodiments. For example, in FIG. 3, the wires 40, 42 which are illustrated as connected to two pins of the privacy structure, can instead be connected to two contact pads of the privacy structure. Similarly, the frame comprising contact pads, which are illustrated as being in electrical communication with other components (e.g., controller, switch), can instead comprise pins in electrical communication with other components. Further, in some embodiments, the privacy structure and the frame can each comprise a variety of combinations of pins and contact pads. For instance, in some such embodiments, the privacy structure can comprise three pins and one contact pad while the frame comprises the complementary three contact pads and one pin. Other combinations of pins and contact pads are contemplated and a person having ordinary skill will appreciate that the privacy structure and the frame can each comprise any number of pins and contact pads which can interface with complementary pins or contact pads on the other of the privacy structure or the frame.

In addition, while the illustrated embodiments of FIG. 3 and subsequent figures depict pins and contact pads, it will be appreciated by a person having ordinary skill that any type of complementary electrical connectors can be used without departing from the scope of the disclosure, which may or may not include a male electrical connector and a complementary female electrical connector. In some examples, at least one of the electrical connectors in each pair of electrical connectors (e.g., one of the electrical connectors carried by the sash or frame) exhibits positional compliance whereby the electrical connector can move, flex, and/or otherwise adjust position in three-dimensional space. The compliance can allow for electrical contact across a range of relative displacements or relative alignments.

In some embodiments, a male electrical connector can be a plug while the female electrical connector can be a socket which can receive the plug. In general, the male and female electrical connectors can be complementary such that the female electrical connectors can be configured to receive the male electrical connectors. In general, any types of electrical connector pairs can be used one of the connector pairs is operatively connected to the movable component and a complementary one of the connector pairs is operatively connected to the stationary element, and the electrical connector pairs can electrically engage and disengage with each other depending on the position of the movable component relative to the stationary component. Accordingly, any reference to a pin and/or contact pad herein can be replaced with other terminology (e.g., a male connector and/or female connector; an electrical connector and/or complementary electrical connector) as also described herein without departing from the scope of the disclosure.

Moreover, each of the privacy structure and the frame can carry any suitable number of electrical connectors to engage with a corresponding number of electrical connectors on the other component to form matched pairs. For instance, in one such example, the privacy structure can carry two or more electrical connectors configured to engage with two or more complimentary electrical connectors carried by the frame. A person having ordinary skill will appreciate other types and combinations of electrical connectors are contemplated and that this disclosure is not otherwise limited in this respect.

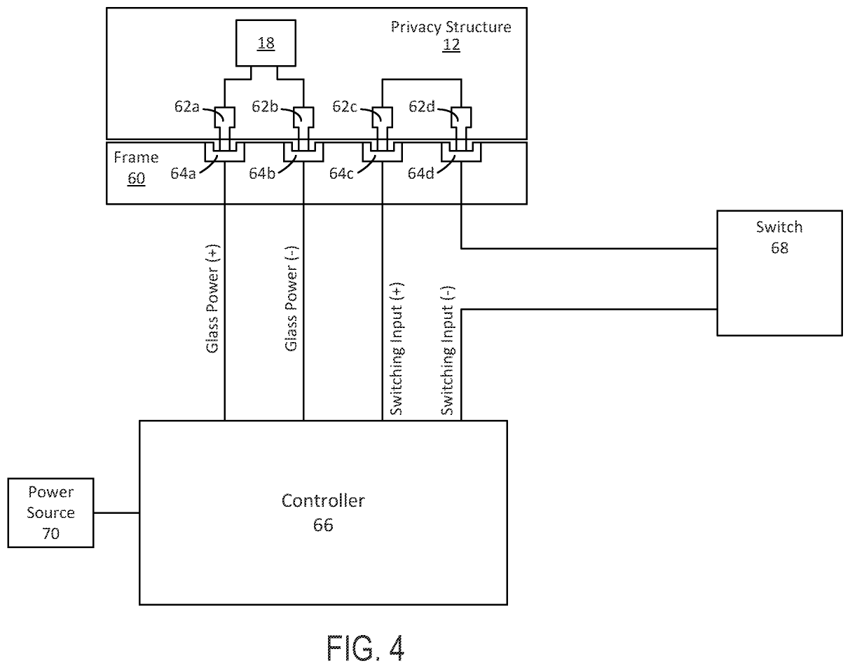

FIG. 4 is a block diagram illustrating an electrical dynamic structure system that includes a privacy structure 12, a frame 60, a controller 66, a switch 68, and electrical connections therebetween. The privacy structure 12 includes a first pin 62a, a second pin 62b, a third pin 62c, a fourth pin 62d and includes an optically controllable optically active material 12. The pins 62a-62d can be made of conductive material, such as metal, to enable the pins to electrically connect to elements of the electrical dynamic structure system. In the embodiment of FIG. 4, the optically controlled optically active material 18 is in electrical communication with the first pin 62a and the second pin 62b. However, the electrically controllable optically active material can be electrically connected to any two or more pins which can provide power to the electrically controllable optically active material. For example, in some embodiments, the privacy structure comprises two pins (e.g., a first pin 62a and a second pin 62b) with the pins configured to provide power. In some embodiments, the privacy structure comprises three pins (e.g., a first pin 62a, a second pin 62b, and a third pin 62c) with two of the three pins configured to provide power. In embodiments where the privacy structure comprises two or more pins, the electrically controllable optically active material can be connected to the two or more pins which can provide power to the electrically controllable optically active material. By connecting the optically controlled optically active material to the two or more pins providing power, the optically controlled optically active material is able to be activated and deactivated.

Continuing with the embodiment of FIG. 4, the frame 60 includes contact pads 64a-d which correspond with the pins 62a-62d of the privacy structure 12. The contact pads include a first contact pad 64a, a second contact pad 64b, a third contact pad 64c, and a fourth contact pad 64d. As illustrated the contact pads 64a-d of the frame 60 are engaged with the pins 62a-d of the privacy structure 12. As the contact pads 64a-d can be made of conductive material, such as metal, the engagement between the pins 62a-d and the contact pads 64a-d can enable electric charge, including power, to flow therebetween. For example, in FIG. 4 the first pin 62a and the second pin 62b are engaged with and electrically connected to the first contact pad 64a and the second contact pad 64b, respectively.

In the embodiment of FIG. 4, the first contact pad 64a and the second contact pad 64b can be electrically connected to the controller 66 (e.g., via one or more wires), which can be further electrically connected to a power source 70. In operation, the controller 66 can receive power from the power source 70 and can provide power to the first and second contact pads 64a, 64b through the electrical connection. As the first and second contact pads 64a, 64b of the frame 60 can be engaged with and in electrical communication with the first and second pins 62a, 62b of the privacy structure, the power provided to the first and second contact pads 64a, 64b can be further provided to the first and second pins 62a, 62b. The power can then be further provided to the electrically controllable optically active material 18 to control the properties of the electrically controllable optically active material 18. In this way, the controller 66 can be connected to the electrically controllable optically active material 18 and can control the properties of the electrically controllable optically active material 18. In some embodiments, the controller 66 includes a positive power connection and a negative/neutral/return connection. For example, in FIG. 4, the first contact pad 64a is electrically connected to the positive power connection of the controller 66 while the second contact pad 64b is electrically connected to the negative/neutral/return connection of the controller 66.

In some implementations the controller 66 can include one or more components configured to process received information, such as a received input from a user interface, and perform one or more corresponding actions in response thereto. Such components can include, for example, one or more application specific integrated circuits (ASICs), microcontrollers, microprocessors, field-programmable gate arrays (FPGAs), or other appropriate components capable of receiving and output data and/or signals according to a predefined relationship.

In some examples, the controller 66 can be configured to use only the two pins and the two contact pads to provide power to and control the electrically controllable optically active material 18 of the privacy structure 12. However, in the embodiment of FIG. 4, the controller can include a switching input comprising two terminals and a switch 68 to control the electrically controllable optically active material 18. As illustrated, the controller's first terminal is electrically connected to the third contact pad 64c. The third contact pad 64c can be engaged by the third pin 62c which is shorted to the fourth pin 62d. The fourth pin 64c can engage the fourth contact pad 64d which can be electrically connected to the switch 68. The switch 68 can be connected back to the second terminal of the controller 66.

In some examples, the controller operates in response to a signal from one or more controls that function as a user interface with the controller. The one or more controls may provide a command to change the optical state of the optically active material. In the embodiment of FIG. 4, the one or more controls can be the switch 68. For instance, a hard switch (e.g., a wall switch proximate an optically dynamic structure) can be electrically connected to the controller and can switch between two or more switching states, each corresponding to an optical state of the optically active material. For example, a first switching state can be an on state, where power is provided by the controller to the electrically controllable optically active material, while a second switch state can be an off state, where the controller is configured to refrain from providing power to the electrically controllable optically active material. Additionally or alternatively, the controller can be configured to communicate with an external component, such as a smartphone or tablet via wireless communication or an internet-connected device (e.g., through a hard-wired or wireless network connection). In some implementations, the controller 66 can receive a signal from such an external device corresponding to a desired optical state of the optically active material and can control the optically active material accordingly, e.g., to transition to that state.

In operation of the embodiment of FIG. 4, the controller 66 can detect if a circuit between the first terminal and the second terminal is completed, which can enable control of the optically active material. For example, the controller can send a signal (e.g., voltage) through the first terminal into the third contact pad 64c. If the third pin 62c is not engaged with the third contact pad 64c, the signal will not travel any further. If, however, the third pin 62c and the fourth pin 62d, which may be electrically shorted together, are engaged with the third contact pad 64c and the fourth contact pad 64d, respectively, the signal can continue to travel through each of the pins and contact pads into the switch 68. Depending on aspects of the switch, such as if the switch is in an on/off position, the signal can stop at the switch or continue back to the second terminal. In the event the signal travels through the entire path from the first terminal to the second terminal, the controller can be configured to start providing or to continue to provide power to the privacy structure via the power connections (e.g., first and second contact pads with first and second pins). In the event the signal does not travel through the entire path, the controller can be configured to refrain from providing power to the privacy structure. For example, the signal can be stopped by either of the third or fourth pins being disengaged from the respective third or fourth contact pads. Additionally or alternatively, the signal can be stopped by the switch (e.g., disconnecting/switching to an off position). Thus, in some embodiments, multiple connections are required before power is provided to the privacy structure by the controller.

It can be desirable to refrain from providing power to the contact pads of the frame when the pins of the privacy structure are not engaged with the contact pads. In some embodiments, the power, including the voltage and current, that is needed to ensure proper operation of the electrically controllable optically active material can be dangerous to persons. For example, if the contact pads 64a, 64b are powered by the controller 66 when the pins 62a, 62b are not engaged with the contact pads, a user should avoid contact with the pads. Thus, embodiments requiring multiple connections before the controller 66 provides power to the contact pads can be desirable for safety purposes.

Further safety configurations may include recessing the contact pads 64a-d of the frame 60 into the frame 60 to prevent a person from easily touching the contact pads regardless of whether the pads are powered or unpowered. Additionally or alternatively, a mechanical guard may be placed overtop the contact pads 64a-d to prevent persons from easily touching or accessing the contact pads. In some embodiments, the mechanical guard can be retractable such that it covers the contact pads when the pins of the privacy structure are not engaged with the contact pads but can be retracted to allow the pins of the privacy structure to engage with the contact pads when the privacy structure engages the frame. Various other types of mechanical guards are contemplated. In some embodiments, weathering protection, such as a gasket sealing the contact pads with the pins, can be used to prevent the electrical connection from being exposed to the elements including water. The gasket can additionally provide a physical barrier which prevents touching of any of the components of the electrical connection.

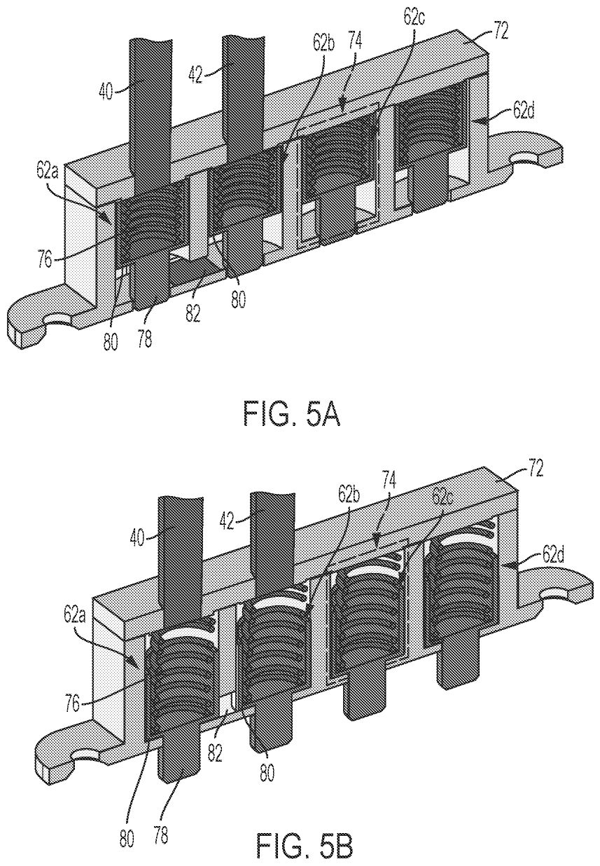

FIG. 5A and FIG. 5B are isometric views of an example multiple pin electrical connection in a compressed and an extended state, respectively, according to an aspect of the present disclosure. In the embodiment of FIG. 5A, the electrical connection comprises a housing 72 that includes four barrels 74 with each of the barrels 74 surrounding a spring. In some embodiments, the housing 72 is contained by a privacy structure 12 (e.g., sash 30) and in some embodiments, the housing 72 is recessed in the privacy structure (e.g., sash 30). The housing 72 may include a plurality of pins, such as a first pin 62a, a second pin 62b, a third pin 62c, and a fourth pin 62d which are in a compressed state.

As illustrated, each of the pins may include a spring 76 and a plunger 78. In operation, the spring 76 can bias the plunger 78 of a pin to maintain an extended state, whereby a portion of the plunger extends beyond the confines of the housing as seen in FIG. 5B. For example, the spring 76 can exert a force against the housing 72 and against the plunger 78 such that the plunger 78, if not acted upon by an outside force, would be in an extended state. In the embodiment of FIG. 5A, however, the plungers 78, and thus the pins of the electrical connection are in a compressed state. As discussed elsewhere herein, the pins 62a-62d can engage with contact pads (e.g., 64a-64d). In some embodiments, when the pins are engaged with the contact pads, the pins can be in a compressed state whereby the plungers 78 of the pins are in physical contact with the contact pads. In some embodiments, the plunger 78 of the pin can include a shoulder 80 which can retain a portion of the plunger 78, and thus the pin, within the barrel 74 of the housing 72. Thus, the shoulder 80 can enable the pin to extend and compress without the pin completely leaving the housing.

Continuing with the embodiment of FIG. 5A, the first pin 62a and the second pin 62b can be electrically connected to wires 40, 42. The wires 40, 42 can be electrically connected to electrode layers of a privacy structure. The first pin 62a and the second pin 62b, when in a compressed state due to being in contact with associated contact pads, can allow power to flow through the contact pads, through the pins, and through the wires 40, 42 to the electrode layers of the privacy structure. As discussed elsewhere herein, the power can be used to control the optical properties of the optically active material in the privacy structure. Even when in an extended state, as seen in FIG. 5B, the first pin 62a and the second pin 62b can be electrically connected to the wires 40, 42 (e.g., via the spring and a contact pad). However, when the first pin 62a and the second pin 62b are in an extended state, the third pin 62c and the fourth pin 62d are also in an extended state. The third pin 62c and the fourth pin 62d are shorted when in a compressed state, as illustrated in FIG. 5A and can further be shorted in an extended state, as illustrated in FIG. 5B. However, in an extended state, the controller's connection through the third pin and the fourth pin can be broken (e.g., disconnected). As the third pin 62c and the fourth pin 62d are used by the controller to switch power to the electrical connector on and off, the third pin 62c and the fourth pin 62d being electrically disconnected (e.g., from corresponding contact pads) can cause the controller to refrain from providing power. Such configurations can keep the pins, including the first and second pins and their complementary contacts, unpowered and safe to the touch.

In some embodiments, when the first pin 62a and the second pin 62b transition from a compressed state to an extended state, such as when the privacy structure comprising the housing 72 is moved away from the frame, some amount of power can be retained within the electrically controllable optically active material. For example, the electrically controllable active material contained in the privacy structure may function as a capacitor that remains charged even when power is withdrawn from the privacy glazing structure.

In some embodiments, an electrical connector configuration according to the disclosure includes a shorting mechanism that can electrically connect pins of the privacy structure (e.g., electrical connectors operatively connected to the privacy glazing structure) together when no power is flowing through the pins. By shorting the pins of the privacy structure together, any remaining electrical charge in the optically active material can rapidly dissipated. However, the shorting mechanism can be configured to prevent shorting between the pins when power is flowing through them.

The embodiment of FIG. 5A and FIG. 5B includes a shorting mechanism in the housing in the form of an electrically conductive shunt 82. As illustrated in FIG. 5A, when the first pin 62a and the second pin 62b are in the compressed position, whereby power can flow from contact pads through the pins and wires 40, 42, and to the optically active material, the conductive shunt 82 is not in contact with either of the pins. This can allow power to flow through the pins without causing a shorting of a power supply providing power to the pins. However, as illustrated in FIG. 5B, when the first pin 62a and the second pin 62b are in the extended position, the shoulders 80 of the first pin 62a and the second pin 62b can contact the electrically conductive shunt 82 and become shorted together.

The electrically conductive shunt 82 can create a conductive path that connects the first pin 62a with the second pin 62b, thereby allowing any remaining electrical charge in the optically active material to be rapidly dissipated (e.g., due to the capacitive load). As described above with respect to FIG. 5B, power may not flow through the first pin 62a and the second pin 62b when the pins are in the extended position due to the controller refraining from providing power when the pins (e.g., the third pin 62c and the fourth pin 62d) are disconnected from their complementary contact pads. With no power flowing through the pins when the pins are extended, the electrically conductive shunt 82 cannot cause a power supply to short.

While in some embodiments, such as FIG. 5A and FIG. 5B, an electrically conductive shunt is used to electrically connect the pins which can provide power to the electrically controllable optically active material, other types of electrical shunting or shorting mechanisms can be employed. For example, in some embodiments, a first pin (e.g., 62a) and a second pin (e.g., 62b) can be angled relative to each other such that when they are in an extended position (e.g., FIG. 5B), a portion of the pins contact each other. In such embodiments, the pins, which can be made of conductive material, are electrically shorted together and can rapidly dissipate any remaining charge in the optically active material to which they are electrically connected. A person having ordinary skill in the art will appreciate other methods of shorting the pins are contemplated. Further, as in some embodiments the electrical connectors can be female connectors (e.g., contact pads), a person having ordinary skill in the art will appreciate that methods of shorting female connectors connected to an optically active material, when not actively providing power to the optically active material, are contemplated.

Electrically shorting the pins connected to the optically active material when not actively being powered can be advantageous as a rapid dissipation of charge within the optically active material can allow the optically active material to revert to substantially scattering light instead of only partially scattering light. Such a functionality can be desired for aesthetic purposes. Additionally, it can be advantageous to electrically short the pins connected to the optically active material when not actively being powered as excess charge held within the optically active material may present an electrical shock risk to users.

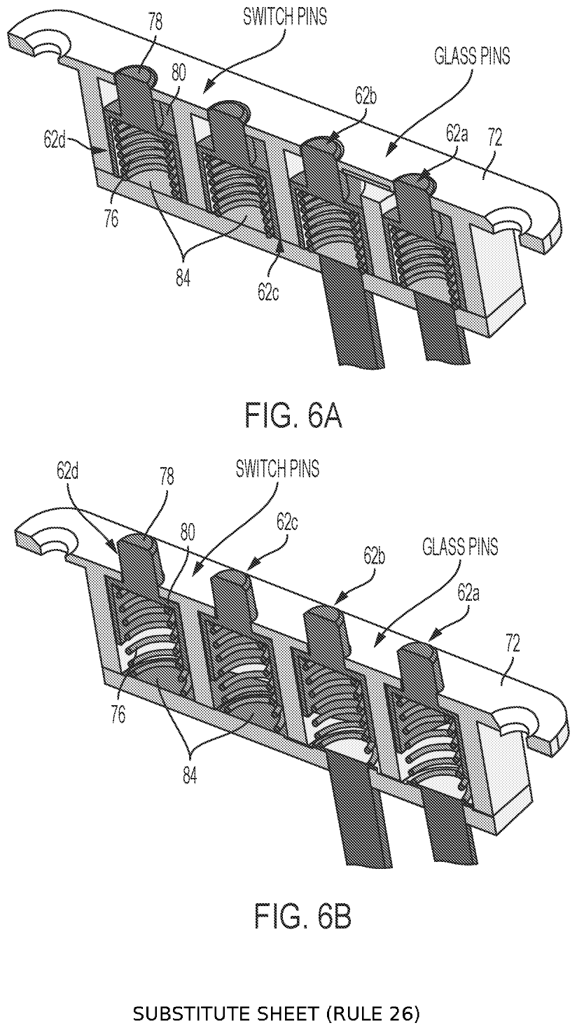

FIG. 6A and FIG. 6B are isometric views of the example four pin electrical connection of FIG. 5A and FIG. 5B in a compressed and an extended state according to an aspect of the present disclosure. As illustrated in FIG. 6A, the switch pins, in this case the third pin 62c and the fourth pin 62d, are electrically shorted together by a conductive plate 84 when the pins are in the compressed state. As discussed elsewhere herein, the compressed state can be when the glass pins, in this case the first pin 62a and the second pin 62b, provide power through them to the optically active material. As illustrated in FIG. 6B, when the switch pins are in the extended position, the switch pins are still electrically shorted together via the conductive plate 84 and the springs of the switch pins. Other methods of electrically shorting the switch pins together are contemplated.

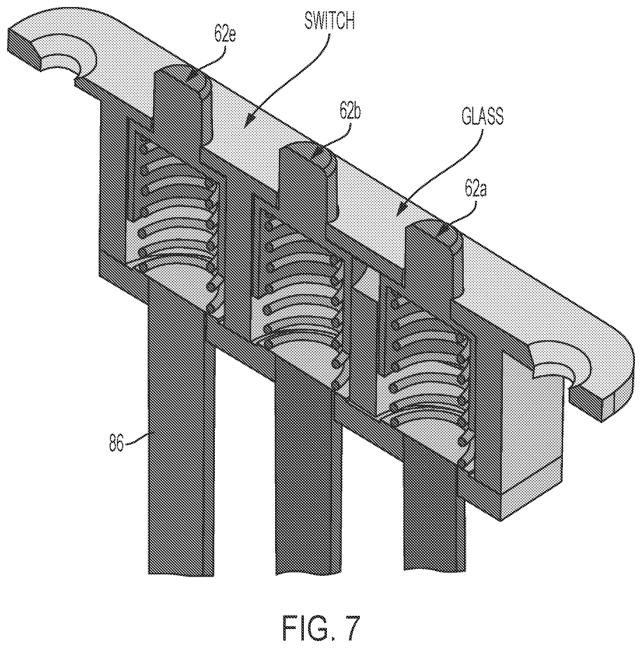

FIG. 7A is an isometric view of an example three pin electrical connection in an extended state according to an aspect of the present disclosure. In comparison to the four pin electrical connections of FIGS. 5A, 5B, 6A, and 6B, the three pin electrical connection can include a first pin 62a and a second pin 62b for providing power to the optically active material while including a third pin 62e as the only pin for electrically connecting a controller, a switch, and the optically active material. In some embodiments, the switch is comprised within the controller. In some embodiments, a privacy structure containing the optically active material can be connected to an electrical ground and the switch, connected to the third pin 62e (e.g., via wiring 86), can be connected to an electrical ground. The connections to ground can enable the third pin 62e, should it extend to an extended state, to break the connections to ground which can alert the switch that power should no longer be delivered to the electrical connector via the first pin 62a and the second pin 62b.

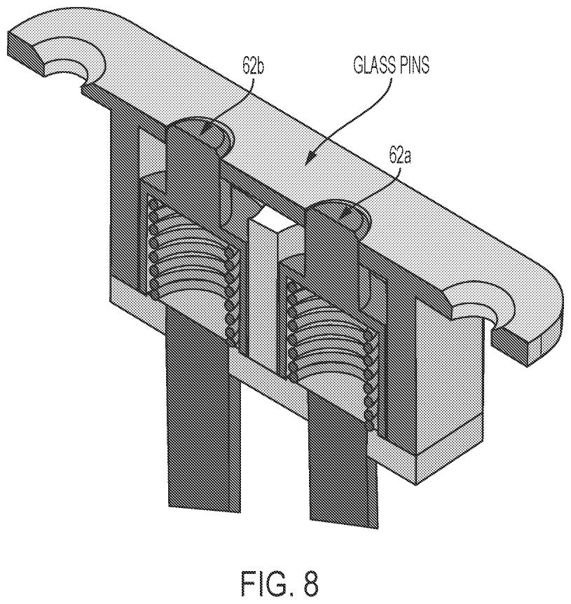

FIG. 8 is an isometric view of an example three pin electrical connection in a compressed state according to an aspect of the present disclosure. In similarity with the embodiments of the other figures, the first pin 62a and the second pin 62b can provide power to the optically active material. However, at least one of the first pin 62a and the second pin 62b can additionally be used to communicate with a controller and/or switch such that power delivered to the optically active material can be stopped when the pins are in the extended position (e.g., not in contact with contact pads).

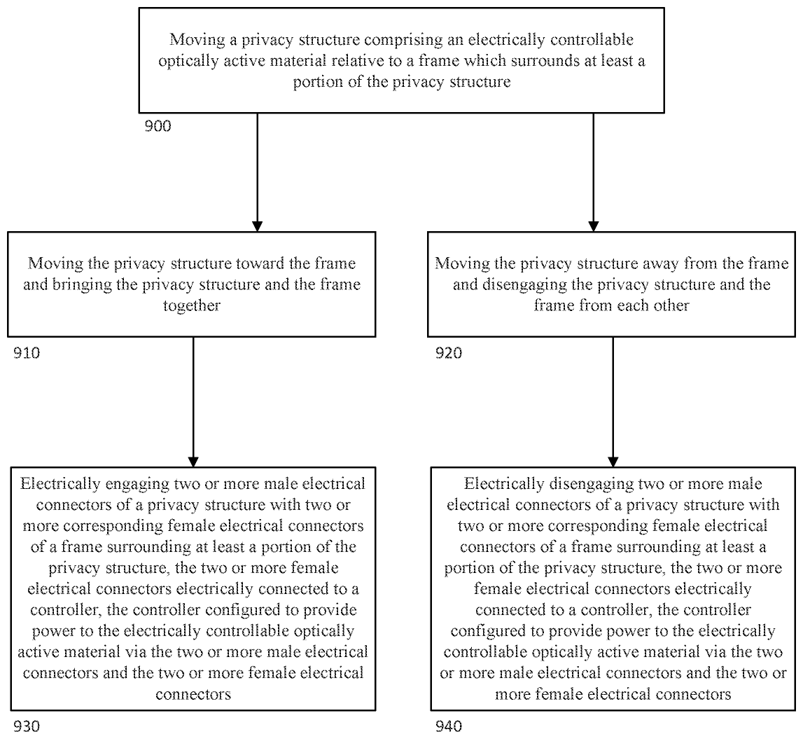

FIG. 9 is a flow chart of an example method of connecting a privacy structure comprising an electrically controllable optically active material to a controller configured to provide power to the electrically controllable optically active material. The method can include moving a privacy structure comprising an electrically controllable optically active material relative to a frame which surrounds at least a portion of the privacy structure as in step 900. For example, a privacy structure can include an openable window that can be moved relative to a window frame that surrounds at least a portion of the openable window.

In some embodiments, the method of FIG. 9 includes moving the privacy structure toward the frame and bringing the privacy structure and the frame together, as in step 910. In some embodiments, however, the method includes moving the privacy structure away from the frame and disengaging the privacy structure and the frame from each other as in step 920.

In the example of FIG. 9, that technique at step 930 includes electrically engaging two or more electrical connectors of the privacy structure with two or more complementary electrical connectors of the frame. The two or more electrical connectors can be electrically connected to a controller configured to provide power to the electrically controllable optically active material via the two or more electrical connectors and the two or more complementary electrical connectors. Further, electrical engagement between the two or more electrical connectors associated with the privacy glazing structure and the two or more complementary electrical connectors associated with the frame can close a circuit with the controller and can provide power to the electrically controllable optically active material.

The example technique of FIG. 9 may include, at step 940, electrically disengaging two or more electrical connectors of the privacy structure from two or more complementary electrical connectors of the frame. The two or more complementary electrical connectors can be electrically connected to a controller with the controller configured to provide power to the electrically controllable optically active material via the two or more electrical connectors and the two or more complementary electrical connectors (when engaged). Further, electrically disengaging the two or more electrical connectors from the two or more complementary electrical connectors can remove power from the electrically controllable optically active material and create a short between the two more electrical connectors associated with the movable privacy glazing structure. The short between the two or more connectors can dissipate electric charge stored within the electrically controllable optically active material.

In general, the term wiring used herein refers to an electrically conductive member (which is optionally flexible under hand pressure), such as a thread of metal optionally covered with an insulative coating, a flexible printed circuit, or other electrical connector facilitating electrical connection. One example type of wiring that may be used is a non-metallic sheathed cable that includes two or more insulated conductors contained in a non-metallic sheath (e.g., polymeric sheath). For example, the non-metallic sheathed cable may include two or three metallic conductors (e.g., copper wires) each individually covered with an insulative polymeric material and all contained within a non-metallic sheath, optionally along with a ground wire (e.g., bare metal copper wire). Each metallic conductor may be formed of a single core of metal or may be formed of multiple cores of metal positioned in contact with each other. When the wiring includes multiple cores, the gauge or thickness of the wire may be determined by the combined thickness of the multiple cores. It will be appreciated that features described as wiring herein may be implemented using one or multiple individual segments of wiring (e.g., joined together) and need not be implemented using a single, continuous section of wiring.

Various examples have been described. These and other examples are within the scope of the following claims.

1. A system comprising:
a privacy structure comprising an electrically controllable optically active material and at least to electrical connectors electrically connected to the electrically controllable optically active material;
a frame surrounding at least a portion of the privacy structure, the frame comprising at least two complementary electrical connectors configured to electrically engage the at least to electrical connectors electrically connected to the electrically controllable optically active material; and
a controller electrically connected to the at least two complementary electrical connectors, wherein the controller is configured to:
provide power to the electrically controllable optically active material via the at least two complementary electrical connectors after the at least two electrical connectors electrically connected to the electrically controllable optically active material electrically engage the at least two complementary electrical connectors of the frame, and
refrain from providing power to the electrically controllable optically active material after the after the at least two electrical connectors electrically connected to the electrically controllable optically active material are electrically disengaged from the at least two complementary electrical connectors.

2. The system of claim 1, wherein the at least two electrical connectors comprise a first electrical connector and a second electrical connector and the at least two complementary electrical connectors comprise a first complementary electrical connector and a second complementary electrical connector, the first electrical connector and the second electrical connector being electrically shorted together when the first electrical connector and the second electrical connector are disengaged from the first complementary electrical connector and the second complementary electrical connector.

3. The system of claim 2, wherein the first electrical connector and the second electrical connector are angled toward each other such that when the privacy glazing structure is moved out of electrical contact relative to the frame, the first electrical connector and the second electrical connector are in electrical contact.

4. The system of claim 1, wherein the privacy structure comprises a third electrical connector and the frame comprises a third complementary electrical connector configured to electrically engage the third electrical connector, the system further comprising a switch electrically connected to the third complementary electrical connector and the controller, the switch configured to activate or deactivate the electrically controllable optically active material via the controller after the third complementary electrical connector has engaged the third electrical connector.

5. The system of claim 1, wherein the privacy structure comprises a third electrical connector and a fourth electrical connector and the frame comprises a third contact pad and a fourth contact pad, the third contact pad and the fourth contact pad configured to electrically engage the third electrical connector and the fourth electrical connector respectively, the system further comprising a switch electrically connected to one of the third contact pad or the fourth contact pad and further electrically connected to a switching input of the controller, the controller electrically connected to the other one of the third contact pad and the fourth contact pad, the controller configured to provide power to the electrically controllable optically active material via the two or more contact pads after the two or more contact pads engage the two or more electrical connectors of the privacy structure and after the switching input is activated by the switch.

6. The system of claim 1, wherein the at least two electrical connectors comprise pins, and the at least to complementary electrical connectors comprise contact pads.

7. The system of claim 6, wherein the privacy structure comprises a housing and wherein the two or more pins are spring loaded pins retained within the housing of the privacy structure.

8. The system of claim 7, wherein each of the two or more pins comprise a plunger and a spring retained within a barrel of the housing, each of the plungers comprising a shoulder configured to retain the plungers in the barrels of the housing, the housing comprising a conductive path configured to electrically short the shoulders of each of the plungers when the two or more pins are in an extended position.

9. The system of claim 6, wherein the two or more pins have different lengths.

10. The system of claim 6, wherein the first pin, second pin, third pin, and fourth pin are staggered and wherein the first contact pad, the second contact pad, the third contact pad, and the fourth contact pad are staggered and configured to receive the staggered pins.

11. The system of claim 1, further comprising:
a first pane of transparent material; and
a second pane of transparent material; wherein
the electrically controllable optically active material is positioned between the first pane of transparent material and the second pane of transparent material, the electrically controllable optically active material being positioned between a first electrode layer and a second electrode layer; and
wherein the controller is electrically connected to the first electrode layer and the second electrode layer via the at least two electrical connectors and the at least two complementary electrical connectors, the controller configured to provide power to the first electrode layer and the second electrode layer after the two or more contact pads receive the at least two electrical connectors of the privacy structure.

12. The system of claim 1, wherein the controller is supplied by a supply voltage and wherein the supply voltage ranges from 100 V to 250 V.

13. The system of claim 1, wherein an operating voltage of the controller is greater than or equal to 50 V.

14. The system of claim 11, further comprising:
a third pane of transparent material; and
a spacer positioned between the second pane of transparent material and the third pane of transparent material to define a between-pane space, the spacer sealing the between-pane space from gas exchange with a surrounding environment and holding the second pane of transparent material a separation distance from the third pane of transparent material.

15. The system of claim 11, wherein the first pane of transparent material and the second pane of transparent material are each laminate panes comprising a pair of glass substrates laminated together.

16. The system of claim 11, wherein the controller is further configured to receive input from a user control located outside of a privacy structure defined by the first pane of transparent material, the second pane of transparent material, and the electrically controllable optically active material.

17. The system of claim 1, wherein the electrically controllable optically active material is a liquid crystal material.

18. A method for removing power from an electrically controllable optically active material of a security privacy structure comprising:
moving a privacy structure comprising an electrically controllable optically active material relative to a frame which surrounds at least a portion of the privacy structure; and electrically disengaging two or more male electrical connectors of a privacy structure with two or more corresponding female electrical connectors of a frame surrounding at least a portion of the privacy structure, the two or more female electrical connectors electrically connected to a controller, the controller configured to provide power to the electrically controllable optically active material via the two or more male electrical connectors and the two or more female electrical connectors; wherein
electrically disengaging the two or more male electrical connectors from the two or more corresponding female electrical connectors removes power from the electrically controllable optically active material and creates a short between the two more male electrical connectors.

19. The method of claim 18, wherein the short created by electrically disengaging the two or more male electrical connectors from the two or more corresponding female electrical connectors dissipates electrical charge within the electrically controllable optically active material.

20. A method for providing power to an electrically controllable optically active material of a security privacy structure comprising:
moving a privacy structure comprising an electrically controllable optically active material relative to a frame which surrounds at least a portion of the privacy structure; electrically engaging two or more male electrical connectors of a privacy structure with two or more corresponding female electrical connectors of a frame surrounding at least a portion of the privacy structure, the two or more female electrical connectors electrically connected to a controller, the controller configured to provide power to the electrically controllable optically active material via the two or more male electrical connectors and the two or more female electrical connectors; wherein
the electrical engagement between the two or more male electrical connectors and the two or more corresponding female electrical connectors closes a circuit with the controller and provides power to the electrically controllable optically active material.
